(19) United States
(12) Patent Application Publication
(10) Pub. No.: US 2026/0317172 A1
(43) Pub. Date: Oct. 15, 2026

(54) Molten Salt Synthesis of Uranium Nitride

(71) Applicant: Oregon State University, Corvallis, OR (US)

(72) Inventors: Victoria Lee Augustine, Corvallis, OR (US); Alexander Theodore Chemey, Corvallis, OR (US); Devin Gray McGlamery, Corvallis, OR (US)

(73) Assignee: Oregon State University, Corvallis, OR (US)

(21) Appl. No.: 19/647,198

(22) Filed: Apr. 14, 2026

Related U.S. Application Data
(60) Provisional application No. 63/788,927, filed on Apr. 15, 2025.
(60) Provisional application No. 63/941,803, filed on Dec. 16, 2025.

(51) Int. Cl. C01B 21/06; B01J 14/00; B01J 19/00

(52) U.S. Cl. CPC C01B 21/063; B01J 14/00; B01J 19/0013; B01J 2219/00051; C01P 2002/72; C01P 2002/74

(57) ABSTRACT

A method for producing uranium nitride, the method including: heating a vessel containing a blend including a uranium source, a chloride salt, a metal nitride, and a reductant under a non-participating cover gas, wherein the vessel is maintained at a reaction temperature and for a reaction time sufficient to produce a molten reaction mixture including the uranium nitride; and isolating the uranium nitride, wherein the uranium source is a uranium oxide or a uranium halide. A system for producing uranium nitride, the system including: a vessel containing a uranium-containing blend and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium nitride.

### CROSS REFERENCE TO RELATED APPLICATIONS

This application claims priority to Provisional Application No. 63/788,927 filed Apr. 15, 2025, and Provisional Application No. 63/941,803 filed Dec. 16, 2025, the disclosures of which are hereby incorporated by reference in their entireties.

### STATEMENT OF GOVERNMENT LICENSE RIGHTS

This invention was made with government support under Award No. DE-NE0009394 awarded by the US Department of Energy. The government has certain rights in the invention.

### BACKGROUND

Uranium nitride (UN) is a useful material in the production of advanced nuclear fuels.

State of the art industrial scale uranium nitride, such as uranium mononitride, is currently synthesized through carbothermal reduction followed by nitridation using gaseous nitrogen at temperatures in excess of 1500° C. for multiple days. This process is energy intensive and inefficient due to the prolonged reaction times at such elevated temperatures and loss of nitrogen from the system. Furthermore, the process required excess nitrogen usage and the inclusion of carbon impurities.

A need exists for a system and method for producing high purity uranium nitride with reduced synthetic and processing costs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, the present disclosure provides a method for producing uranium nitride (“UN”), the method including: heating a vessel containing a blend including a uranium source, a chloride salt, a metal nitride, and a reductant under a non-participating cover gas, wherein the vessel is maintained at a reaction temperature and for a reaction time sufficient to produce a molten reaction mixture including the uranium nitride; and isolating the uranium nitride, wherein the uranium source is a uranium oxide or a uranium halide.

In some embodiments, the uranium oxide is selected from the group consisting of UO₂, UO₃, and UOₓ, where 1.9≤x<3.

In some embodiments, the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

In some embodiments, the uranium halide is a mixed metal uranium halide.

In some embodiments, the chloride salt is selected from the group consisting of LiCl, NaCl, KCl, CaCl₂, and MgCl₂.

In some embodiments, the chloride salt includes a first chloride salt and a second chloride salt having a binary ratio of the first chloride salt and the second chloride salt, wherein the binary ratio is about a eutectic ratio.

In some embodiments, the metal nitride is an alkali metal nitride or an alkaline earth metal nitride.

In some embodiments, the alkali metal nitride is Li₃N or Na₃N.

In some embodiments, the alkaline earth metal nitride is Mg₃N₂ or Ca₃N₂.

In some embodiments, the reductant is an alkali metal, an alkaline earth metal, an alkali metal hydride, or an alkaline earth metal hydride.

In some embodiments, the reductant is selected from the group consisting of Li, Na, Mg, Ca, LiH, NaH, KH, CaH₂, MgH₂, and RbH.

In some embodiments, the non-participating cover gas is nitrogen, CO₂, or a noble gas.

In some embodiments, the vessel is an alumina vessel, a nickel vessel, a tantalum vessel, or a molybdenum vessel.

In some embodiments, the vessel is configured to produce uranium nitride in a batch process.

In some embodiments, the vessel is configured to produce uranium nitride in a flow process.

In some embodiments, the reaction temperature is between about 600° C. and 900° C.

In some embodiments, the reaction time is less than 24 hours, less than 10 hours, less than 8 hours, less than 6 hours, less than 4 hours, less than 2 hours, or less than 1 hour.

In some embodiments, the method further includes cooling the molten reaction mixture to a temperature below the melting point of the chloride salt to provide the uranium nitride and a salt byproduct.

In some embodiments, the method further includes rinsing the cooled molten reaction mixture with a polar aprotic solvent.

In some embodiments, the polar aprotic solvent is tetrahydrofuran (THF), dimethylformamide (DMF), or dimethyl sulfoxide (DMSO).

In some embodiments, cooling the molten reaction mixture includes cooling at a cooling rate.

In some embodiments, the cooling rate is between about 0.1° C./min to about 10° C./min.

In some embodiments, a stoichiometric ratio of the blend is 1 mole uranium source: between 1 mole and 2 moles alkali metal nitride: between 1 mole and 10 moles reductant: between 1.2 moles and 25 moles chloride salt.

In some embodiments, isolating the reaction includes hot filtering the reaction mixture, thereby providing the uranium nitride.

In an aspect, the present disclosure provides a composition including the uranium nitride produced by any of the methods described herein.

In an aspect, the present disclosure provides a method for producing uranium nitride, the method including: heating a nickel crucible containing a blend including a uranium source, Li₃N, Li or LiH, and LiCl under argon gas, wherein the nickel crucible is maintained at a reaction temperature of between about 700° C. and about 900° C. for 2 hours, thereby providing uranium nitride; and isolating the uranium nitride, wherein the uranium source is a uranium oxide or a uranium halide.

In an aspect, the present disclosure provides a system for producing uranium nitride, the system including: a vessel including a uranium-containing blend for forming a uranium nitride and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium nitride produced by the reaction of the uranium-containing blend.

In some embodiments, the vessel is a zirconia vessel, a nickel vessel, a tungsten vessel, a tantalum vessel, a stainless-steel vessel, or a molybdenum vessel.

In some embodiments, the uranium-containing blend includes a uranium source, a chloride salt, a metal nitride, and a reductant, wherein the uranium source is a uranium oxide or a uranium halide.

In some embodiments, the heating element is further configured to cool the vessel to a temperature below the melting point of the chloride salt.

In some embodiments, the reaction temperature is between about 600° C. and 900° C.

In some embodiments, the processing zone is a batch processing zone configured to isolate uranium nitride in a batch process.

In some embodiments, the processing zone is a flow processing zone configured to continuously isolate uranium nitride in a flow process.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 depicts a system for producing uranium nitride, according to embodiments of the present disclosure;

FIG. 2 depicts a process for producing uranium nitride, according to embodiments of the present disclosure;

FIG. 3 depicts (a) powder XRD analysis of UBr₅-derived uranium nitride, and (b) powder XRD analysis of UCl₄-derived uranium nitride, according to embodiments of the present disclosure;

FIG. 4 depicts powder XRD (pXRD) analysis of UN synthesized form UO₂ at (a) 825° C. and (b) 775° C.; and

FIG. 5 depicts powder XRD analysis of UN synthesized form UO₃ at (a) 825° C. and (b) 775° C.

### DETAILED DESCRIPTION

The present disclosure addresses these needs for a system and method for producing high purity uranium nitride with reduced synthetic and processing costs and related needs by providing systems and methods for producing uranium nitride. An advantage of the present disclosed systems and methods is the reduced reaction time, reduced energy costs, and improved nitrogen retention relative to existing systems and methods.

### Systems for Producing Uranium Nitride

In an aspect, the present disclosure provides a system for producing uranium nitride, the system including: a vessel including a uranium-containing blend for forming a uranium nitride and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium nitride produced by the reaction of the uranium-containing blend.

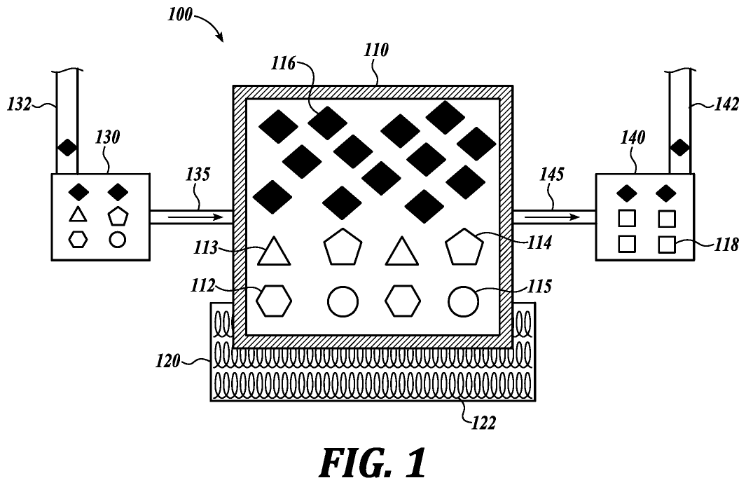

In this regard, FIG. 1 provides a schematic illustration of a system 100 for producing uranium nitride. It should be understood that system 100 is provided as an example of a system capable of carrying out the methods described in the present disclosure, and that other configurations of the various elements of system 100 may be used. Moreover, not every element illustrated in system 100 may be required to perform the methods described herein, and that additional elements may be incorporated into system 100 within the achievement of one having ordinary skill in the art. In this regard, it should be understood that certain embodiments of the systems described herein may be described in relation to various method steps, and certain embodiments of the methods described herein may be described in relation to various system elements.

System 100 includes a vessel 110 which includes within it a uranium-containing blend. In some embodiments, the uranium-containing blend includes uranium source 112, chloride salt 113, metal nitride 114, and reductant 115. Vessel 110 further includes a non-participating cover gas 116.

Vessel 110 contacts heating element 120 with heating coils 122. Vessel 110 may, in some embodiments, be coupled to input source 130 (such as for providing additional uranium source 112, chloride salt 113, metal nitride 114, reductant 115, and/or non-participating cover gas 116) via input coupling 135. Similarly, vessel 110 may, in some embodiments, be coupled to processing zone 140 via processing coupling 145. Processing zone 140 may be an integrated component of vessel 110, or may be an external region for processing of product from vessel 110.

Input source 130 may include cover gas supply 132 for introducing non-participating cover gas 116 into the input source 130. For instance, in a flow process, non-participating cover gas 116 is introduced into input source 130, which then enters the vessel 110 via input coupling 135 with the uranium source 112, chloride salt 113, metal nitride 114, and reductant 115. An advantage of this embodiment is that reactive gases may be purged from the system prior to heating to prevent contamination. However, it should be understood that other methods of introducing non-participating cover gas 116 are within the scope of this disclosure, such as where non-participating cover gas 116 is introduced directly into vessel 116.

Similarly, in a flow process, uranium source 112, chloride salt 113, metal nitride 114, and reductant 115 may be introduced continuously to vessel 110, such as by using a conveyor to continuously transfer uranium source 112, chloride salt 113, metal nitride 114, and reductant 115 into the vessel 110.

Conversely, in a batch process, uranium source 112, chloride salt 113, metal nitride 114, reductant 115, and non-participating cover gas 116 may be introduced in a process step before the vessel 110 is heated. This would permit purging of contaminant gases from the system prior to the heating process being initiated.

Uranium source 112, chloride salt 113, metal nitride 114, reductant 115 react under non-participating cover gas 116 within the vessel 110 to produce a uranium nitride product 118, depicted within processing zone 140. While uranium nitride product 118 is depicted within processing zone 140 for clarity, it should be understood that uranium nitride product 118 is produced continuously within vessel 110 and thus may also be located within vessel 110 prior to isolation at processing zone 140.

Accordingly, in some embodiments, when uranium nitride product 118 is produced in vessel 110, it may be transported via processing coupling 145 to the processing zone 140. Non-participating cover gas 118 may accompany uranium nitride product 118 to be subsequently vented and/or recirculated through cover gas vent 142. In some embodiments, a continuous process such as in a flow reactor proceeds by mixing reagents together and feeding the mixed reagents into a reaction chamber (such as a heated tube). The reaction chamber may be configured to provide the appropriate residence time within the reaction zone. After the appropriate residence time in vessel 110, the reaction product mixture may exit the reactor and uranium nitride product 118 would be separated by one or more of hot filtration to remove solid uranium nitride product 118 from the molten mixture; density separation of uranium nitride product 118 from the molten reaction mixture such as by centrifugation; and/or washing of the reaction mixture with a solvent such as THE, DMF, or DMSO to isolate the uranium nitride product 118 from the chloride salt component.

In some embodiments, such as in a batch process, after a reaction time has elapsed, heating may cease and isolation steps may be taken at processing zone 140 to collect the uranium nitride product 118. For instance, the vessel 110 may be cooled, leading to crystallization and separation of the uranium nitride product 118 from the salt byproducts. During this cooling and crystallization process, the uranium nitride product 118 may be rinsed and filtered from the rinsate reaction mixture.

In some embodiments, the vessel is a zirconia vessel, a nickel vessel, a tungsten vessel, a tantalum vessel, a stainless-steel vessel, or a molybdenum vessel.

In some embodiments, the uranium-containing blend includes a uranium source, a chloride salt, a metal nitride, and a reductant, wherein the uranium source is a uranium oxide or a uranium halide.

In some embodiments, the heating element is further configured to cool the vessel to a temperature below the melting point of the chloride salt.

In some embodiments, the reaction temperature is between about 600° C. and 900° C.

In some embodiments, the processing zone is a batch processing zone configured to isolate uranium nitride in a batch process.

In some embodiments, the processing zone is a flow processing zone configured to continuously isolate uranium nitride in a flow process.

### Processes for Producing Uranium Nitride

In an aspect, the present disclosure provides a method for producing uranium nitride, the method including: heating a vessel containing a blend including a uranium source, a chloride salt, a metal nitride, and a reductant under a non-participating cover gas, wherein the vessel is maintained at a reaction temperature and for a reaction time sufficient to produce a molten reaction mixture including the uranium nitride; and isolating the uranium nitride, wherein the uranium source is a uranium oxide or a uranium halide.

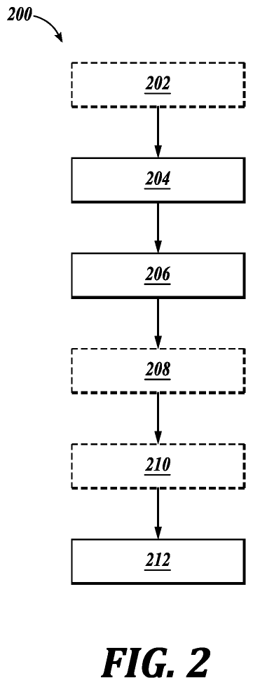

In this regard, FIG. 2 provides a process 200 for producing uranium nitride. Process 200 begins with optional process step 202 combining reagents (i.e., uranium source 112, chloride salt 113, metal nitride 114, and reductant 115) under a non-participating cover gas in a vessel (such as vessel 110). Once the reagents and the non-participating cover gas are combined together within a vessel, at process step 204 the vessel is heated. Subsequently, at process step 206 uranium nitride product is provided by reactions between the reagents under the non-participating cover gas.

Once uranium nitride product is produced, optional process step 208 provides for a cooling of the vessel to encourage solidification of chloride salt 113, and optional process step 110 provides for rinsing the cooled mixture to leave behind the uranium nitride product. This together may, in some embodiments, facilitate the subsequent process step 212 of isolating uranium nitride from the reagents.

It should be understood though that in some embodiments, the uranium nitride may be separated according to other approaches as described further herein below and no cooling step 208 or rinsing step 210 is required.

An advantage of the presently disclosed method is the increased atom efficiency with respect to nitrogen. Uranium nitride fuels may be improved with the selective inclusion of nitrogen-15 isotopes, which naturally have a prevalence of about 0.36%, with the remainder being nitrogen-14. In traditional methods of producing uranium nitride, byproducts are produced that consume a non-trivial quantity of nitrogen-15 present in the nitrogen gas used by the reaction mixture. This results in an expensive atom inefficiency, whereas the present method may use a larger percentage of nitrogen-15 present in the reaction mixture as a solid feedstock, thereby improving costs further.

In some embodiments, the uranium oxide is selected from the group consisting of UO₂, UO₃, and UOₓ, where 1.9≤x<3. In this regard, the uranium oxide may include uranium oxides such as U₃O₈ or U₂O₅, or the uranium oxide may be a non-stoichiometric mixture of uranium oxides.

In some embodiments, the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

In some embodiments, the uranium halide is a mixed metal uranium halide.

In some embodiments, the chloride salt is selected from the group consisting of LiCl, NaCl, KCl, CaCl₂, and MgCl₂. In some embodiments, the chloride salt may include one chloride salt species, two chloride salt species, or three or more chloride salt species. In some embodiments, the chloride salt may include one chloride salt species, two chloride salt species, or three or more chloride salt species. In some embodiments, the chloride salt includes a first chloride salt and a second chloride salt having a binary ratio of the first chloride salt and the second chloride salt, wherein the binary ratio is about a eutectic ratio. In some embodiments, the eutectic ratio for a chloride salt comprising LiCl and KCl is about a 60/40 molar ratio. In some embodiments, the eutectic ratio for a chloride salt comprising CaCl₂) and LiCl is about a 35/65 molar ratio. In some embodiments, the eutectic ratio for a chloride salt comprising CaCl₂) and KCl is about a 26/74 molar ratio. In some embodiments, the eutectic ratio for a chloride salt comprising CaCl₂) and LiCl is about a molar 74/26 ratio. In some embodiments, the eutectic ratio for a chloride salt comprising NaCl and KCl is about a 50/50 molar ratio. In some embodiments, a binary ratio of first and second non-oxide salts that is a eutectic ratio may advantageously be used to provide a mixture at a lower melting point than either component alone. This may result in additional cost savings for methods according to the present disclosure because a lower operating temperature may be maintained.

In some embodiments, the metal nitride is an alkali metal nitride or an alkaline earth metal nitride. The alkali metal nitride may be Li₃N or Na₃N. The alkaline earth metal nitride may be Mg₃N₂ or Ca₃N₂.

In some embodiments, the reductant is an alkali metal, an alkaline earth metal, an alkali metal hydride, or an alkaline earth metal hydride. In some embodiments, the reductant is selected from the group consisting of Li, Na, Mg, Ca, LiH, NaH, KH, CaH₂, MgH₂, and RbH.

In some embodiments, the non-participating cover gas is nitrogen or a noble gas.

In some embodiments, the vessel is an alumina vessel, a nickel vessel, a tantalum vessel, or a molybdenum vessel. In some embodiments, the vessel is configured to produce uranium nitride in a batch process. In some embodiments, the vessel is configured to produce uranium nitride in a flow process.

In some embodiments, the reaction temperature is between about 600° C. and 900° C. Without wishing to be bound by any particular theory, a lower reaction temperature may be advantageous as selectively producing uranium nitride product over other nitride byproducts. However, it should be understood that higher or lower temperatures may be used and are within the scope of the present disclosure. For instance, a higher temperature may promote a faster reaction, whereas a lower temperature may additionally lower energy costs and lead to operational savings. Such higher temperatures may additionally be used where the chloride salt has a higher melting point, and lower temperatures may additionally be used when the chloride salt has a lower melting point.

In some embodiments, the reaction time is less than 24 hours, less than 10 hours, less than 8 hours, less than 6 hours, less than 4 hours, less than 2 hours, or less than 1 hour. In some embodiments, the reaction time is determined by the time required to achieve the reaction temperature. In some embodiments, the reaction time is at least 10 minutes, at least 30 minutes, or at least 1 hour. In some embodiments, the reaction time is based on both the reaction temperature and the volume of the reaction mixture. In some embodiments, the reaction time is between about 1 hour and about 8 hours.

In some embodiments, the method further includes cooling the molten reaction mixture to a temperature below the melting point of the chloride salt to provide the uranium nitride and a salt byproduct. In some embodiments, the method further includes rinsing the cooled molten reaction mixture with a polar aprotic solvent. In some embodiments, the polar aprotic solvent is a polar aprotic solvent suitable to solubilize the chloride salt. In some embodiments, the polar aprotic solvent is tetrahydrofuran (THF), dimethylformamide (DMF), or dimethyl sulfoxide (DMSO). The advantage of THF is that THF is capable of removing LiCl salts, such as those produced as byproducts in the Examples. However, other polar solvents may be used advantageously to remove other salt byproducts, and accordingly fall within the scope of the present disclosure.

In some embodiments, cooling the molten reaction mixture includes cooling at a cooling rate. In some embodiments, the cooling rate is between about 0.1° C./min to about 10° C./min. Without wishing to be bound by any particular theory, a slower cooling rate may improve the purity and increase the crystal size of the uranium nitride crystals produced by the method. Conversely, a faster cooling rate may increase the surface area of crystalline uranium nitride produced.

In some embodiments, isolating the reaction includes hot filtering the reaction mixture, thereby providing the uranium nitride. For example, in hot filtering, uranium nitride may first be synthesized, followed by an additional cycle of heating with the addition of fresh chloride salt. Following this additional heating step, the excess chloride salt may be poured off from the reaction mixture, leaving behind the uranium nitride.

In some embodiments, a stoichiometric ratio of the blend is 1 mole uranium source: between 1 mole and 2 moles alkali metal nitride: between 1 mole and 10 moles reductant: between 1.2 moles and 25 moles chloride salt.

In an aspect, the present disclosure provides a composition including the uranium nitride produced according to any of the methods described herein. In some embodiments, the composition comprises trace chloride contamination from the chloride salt. In some embodiments, the composition comprises trace oxides of the reductant, such as Li₂O when the reductant is LiH.

In some embodiments, a crystalline size of the uranium nitride produced by any of the methods described herein is between about 200 and about 500 Å. In some embodiments, larger particle sizes have lower surface area and higher uranium density. In some embodiments, smaller particle sizes may be used for sintering pellets. An advantage of uranium nitride crystals of this size is an increased packing density when fuel pellets are formed of the uranium nitride, such as for rods used in nuclear fuel. The reduced surface area resulting from the relatively large crystalline size may result in improved energy extraction or reduced corrosion, both important factors in selecting a suitable nuclear fuel. This increased packing density may improve the performance of nuclear fuel generated by uranium nitride produced according to the methods of the present disclosure. In some embodiments, improving the performance of nuclear fuel includes improving the efficiency of the nuclear fuel, where efficiency is defined as a total time in operation between fuel changes. In some embodiments, efficiency is defined by the total burnup of fissile material per irradiation cycle. In some embodiments, efficiency is defined as increasing thermal conductivity of the fuel, thus increasing the ratio of electrical energy output to nuclear energy released.

In an aspect, the present disclosure provides a method for producing uranium nitride, the method including: heating a nickel crucible containing a blend including a uranium source, Li₃N, Li or LiH, and LiCl under argon gas, wherein the nickel crucible is maintained at a reaction temperature of between about 700° C. and about 900° C. for 2 hours, thereby providing uranium nitride; and isolating the uranium nitride, wherein the uranium source is a uranium oxide or a uranium halide.

### Definitions

As used herein, “about” in reference to a numerical value refers to the range of values somewhat less or greater than the stated value, as understood by one of skill in the art. In this manner, the term “about” could mean a value ranging from plus or minus a percentage (±5%) of the stated value. Furthermore, since all numbers, values, and expressions referring to quantities used herein are subject to the various uncertainties of measurement encountered in the art, then unless otherwise indicated, all presented values may be understood as modified by the various uncertainties of the respective measurements encountered in the art.

As used herein, “salt” refers to a combination of one or more of a positively charged cation and one or more of a negatively charged anion having any ionic chemical formula.

As used herein, “chloride salt” refers to an ionic composition including at least one cation and at least one chloride anion.

As used herein, “reductant” refers to metal or metal hydride species capable of acting as a reducing agent for uranium ions during the method steps.

As used herein, a “non-participating cover gas” refers to a gas environment contacting the reaction mixture that is substantially free of chemically reactive gases (i.e., inert), including oxygen, water, methane, ammonia, ozone, nitrous oxides, etc.

As used herein, “vessel” refers to any container suitable for containing the various reagents and capable of being held at the temperatures required for the reaction to proceed, such as a crucible, or a continuous flow reactor.

As used herein, “molten reaction mixture” refers to the solution, colloidal mixture, suspension, or other mixture, formed by the combination of uranium precursor material, a chloride salt, a metal nitride, a reductant, and that may also contain the products generated by the reaction thereof. In a non-limiting example, the uranium precursor material may be uranium oxide.

As used herein, a “blend” refers to mixture or combination of two or more solid compositions. Such mixtures may be heterogeneous or homogeneous with respect to their compositions. The solid compositions may be powders, crystals, flakes, ingots, or any other solid form in which the relevant composition may be formed.

As used herein, a “mixed metal uranium halide” refers to an alkali-salt-soluble ternary, quaternary, quinary, or higher mixed metal uranium halide, such as K₂UCl₆, NaRbUCl₆, etc. A “mixed metal uranium halide” thus represents a salt-soluble species (i.e., one that may be dissolved in a molten salt).

As used herein, “uranium nitride” refers to uranium mononitride, uranium sesquinitride, uranium dinitride, and/or combinations thereof.

As used herein, “uranium containing blend” refers to a blend wherein one or more components of the blend contain uranium atoms.

### EXAMPLES

For clarity and brevity, a procedure for generating uranium nitride is described at a batch production laboratory scale. However, it should be understood that a person of ordinary skill in the art would be able to adapt the experimental procedures described herein for other purposes, including a continuous production laboratory scale synthesis, an industrial batch production industrial scale, a continuous production industrial scale, and other variations.

### Example 1: Molten Salt Synthesis of Uranium Nitride from Uranium Tetrachloride

In an embodiment, the present disclosure provides a molten salt synthesis (MSS) route to UN at 900° C. using LiH as reductant and LiCl as the reaction medium. The method was tested on UCl₄, precursors and achieves complete conversion to UC within 1 h. Products are isolated by dissolving LiCl in polar aprotic solvents (e.g., DMF or THF).

### Methods

UCl₄, Li₃N, LiH, and LiCl were combined in a 1:2:10:25 molar ratio (uranium as the limiting reagent). A typical lab-scale batch synthesis contained 62.3 mg (0.2 mmol) UCl₄, 10.4 mg (0.4 mmol) Li₃N, 11.9 mg (1.5 mmol) LiH, and 159.0 mg (3.8 mmol) LiCl. Powders were mixed in a mortar and pestle, loaded into a ~5 mL tantalum crucible, and heated at 10° C. min⁻¹ to 900° C. After a 1 h dwell, the furnace was cooled at 10° C. min⁻¹ to room temperature. Products were collected by washing with DMF to dissolve LiCl, then rinsed with THF and dried under reduced pressure.

### Results

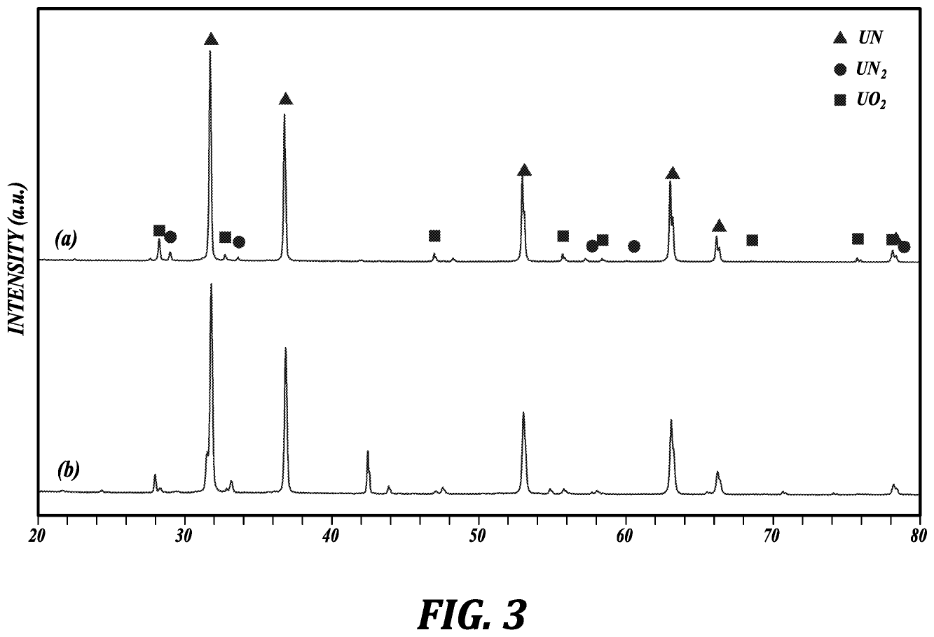

Powder XRD patterns of UCl₄-derived UN can be seen in FIG. 3 panel (b). Reflections associated with the cubic UN structure dominate the diffraction pattern, only minor contributions from UO₂ and a metastable Li—O—Cl phase can be seen.

### Example 2: Molten Salt Synthesis of Uranium Nitride from Uranium Oxide

### Methods

All manipulations were conducted within an argon filled glovebox. Reagents, UO₂ or UO₃ and Li₃N were combined in a 1:2 molar ratio while a stochiometric ratio of Li to UO₂ or UO₃ was used. In other experiments, the molar ratio was 1:1, 1:3, 1:4, and between about 1:1 and about 1:4. Reagents were then added to 1.2 moles of LiCl and added to nickel crucibles. In other experiments, more or less LiCl may be used. The crucibles were placed into a muffle furnace within the glove box, heated to 775° C., 825° C., or 900° C. and held at temperature for 2 hours before cooling at a rate of 1.2° C. min-1 to 450° C.

The crucibles were then ambiently cooled to room temperature. The crude material was then analyzed using powder X-ray diffraction (pXRD). Additionally, samples can be washed with tetrahydrofuran (THF) to remove LiCl.

In some embodiments, chemical reactions for UO₂ and UO₃ starting materials are shown in Equations 1 and 2.

$${UO}_{2} + {Li}_{3} N + Li {\to }^{△} UN + 2 {Li}_{2} O \qquad ( 1 )$$

$${UO}_{3} + {Li}_{3} N + 3 Li {\to }^{△} UN + 3 {Li}_{2} O \qquad ( 2 )$$

### Material Characterization

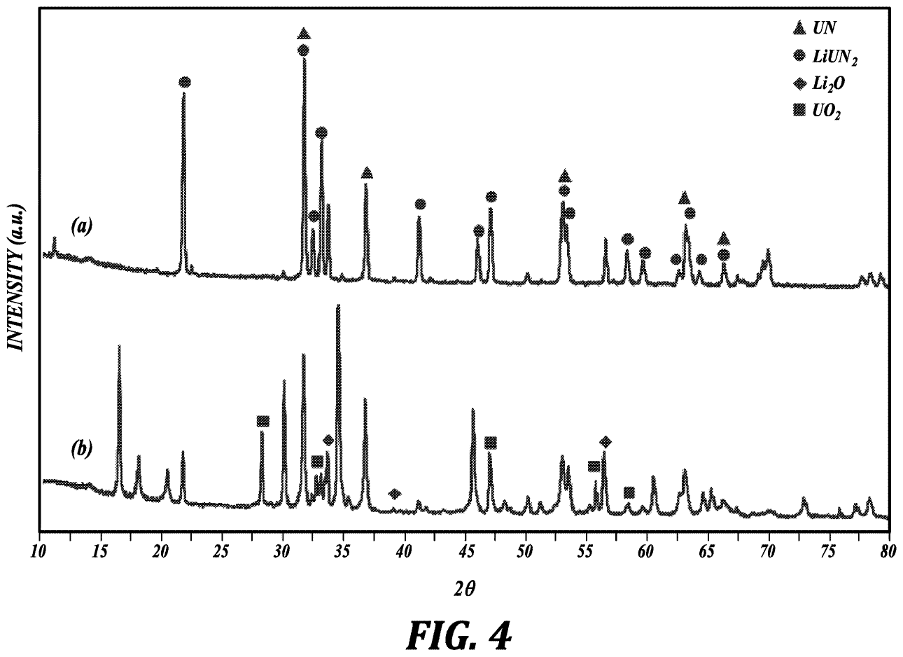

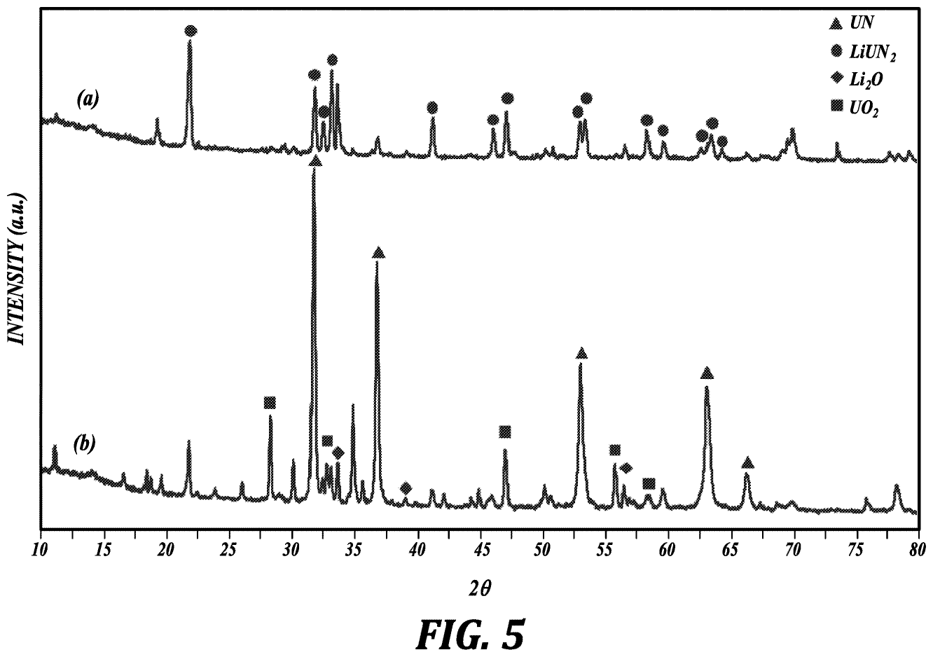

FIGS. 4 and 5 show the pXRD patterns of crude UN synthesized using UO₂ and UO₃ at two temperatures. UN exhibits characteristic 111, 200, 220, 311, and 222 reflections at 2θ values of 31.70°, 36.77°, 52.98°, 63.07°, and 66.22° respectively.

Table 1 shows the phases present in the samples from FIGS. 4 and 5 and the relative weight percents (wt. %). From the pXRD analysis it is observed UN forms alongside the ternary nitride; LiUN₂. The byproduct Li₂O was formed as stated in Equations 1 and 2. From pXRD analysis, the relative wt. % of LiUN₂ is greater than UN when synthesized at 825° C. while at 775° C. there is a greater amount of UN than LiUN₂ which suggest UN formation favors lower synthesis temperatures. At 775° C. there was unreacted oxide material present.

TABLE 1
Quantitative phase distribution of uranium oxide derived
uranium nitride under molten salt conditions

| Oxide | Temperature | UN | UO₂ | LiUN₂ | Li₂O | LiCl |
|---|---|---|---|---|---|---|
| Reagent | (°C) | (wt. %) | (wt. %) | (wt. %) | (wt. %) | (wt. %) |
| UO₂ | 825 | 10.9(2) | 0 | 18.3(3) | 66.4(7) | 4.5(5) |
| UO₂ | 775 | 12.6(10) | 4.8(5) | 4.0(7) | 78.6(17) | 0 |
| UO₃ | 825 | 3.36(14) | 0 | 15.0(4) | 66.3(11) | 15.3(11) |
| UO₃ | 725 | 13.5(5) | 4.0(2) | 6.4(3) | 76.2(9) | 0 |

### Analysis

UN was synthesized at various temperatures using a novel molten salt synthesis (MSS) method. This method demonstrates the formation of UN using various uranium oxide materials as feedstock while using a solid nitrogen precursor leading to high atom efficiency than current industrial methods. This novel MSS method allows for UN to be synthesized without carbon impurities at temperatures less than 800° C. all within a few hours leading to reduced cost of production.

### Example 3: Molten Salt Synthesis of Uranium Nitride from Uranium Halides

### Methods

Within an argon or nitrogen filled glovebox, anhydrous chloride salt, UBr₅ or UCl₄, Li₃N, and a reductant were combined in stochiometric ratios of 1 mole UXₙ, 2 mole Li₃N, 10 mole reductant and 25 mole anhydrous chlorine salt. The idealized reaction using LiH as a reductant to form UN is seen in Equation 3. The reaction mixture was loaded into a tantalum crucible and placed into the center of a chamber furnace within an argon filled glovebox and heated to the reaction temperature of 600° C.-900° C. where it was held for 1 to 8 hours then the reaction was allowed to cool to below the melting point of the chosen chlorine salt system.

At this point the reaction mixture was washed with dimethylformamide (DMF) or tetrahydrofuran (THF) to remove any salts in the reaction mixture, leaving behind a mixture of uranium nitride. The phase distribution of the product mixture may be tailored based on the reaction temperature, time, and reductant concentration.

$${UBr}_{5} + {Li}_{3} N + 2 LiH {\to }^{△} UN + 5 LiBr + {H}_{2} \qquad ( 3 )$$

### Material Characterization:

Table 2 describes the quantitative phase distribution of uranium nitride products derived from processed UN synthesized using UBr₅ and UCl₄ as the respective starting material and using Li₃N as a solid nitrogen source. Powder XRD patterns of UBr₅-derived UN can be seen in FIG. 3 panel (a).

TABLE 2
Quantitative phase distribution of uranium halide derived
uranium nitride under molten salt conditions

| | UN | U₂N₃ | UN₂ | UO₂ |
|---|---|---|---|---|
| Uranium Halide Reagent | (Wt. %) | (Wt. %) | (Wt. %) | (Wt. %) |
| UCl₄ | 63 ± 2 | 24 ± 3 | 5 ± 1 | 7 ± 1 |
| UBr₅ | 88 ± 2 | 4 ± 1 | 0 | 8 ± 1 |

### Analysis:

Uranium mononitride mixed with uranium sesquinitride and uranium dinitride have been synthesized using a novel molten salt synthesis method using various uranium halide starting materials. The product distribution ratio can be tuned by varying reaction time, temperature, and reductant concentrations.

This method allows for the formation of uranium nitrides at temperatures and times well below what is currently used in industrial applications to generate equivalent material. This novel molten salt synthesis method allows for the synthesis of uranium nitrides in a matter of hours at temperatures well below 1000° C. with improved atom efficiency compared to state-of-the-art methods. This method reduces synthetic cost and improves scalability. The use of uranium halide starting material is advantageous as isotope enrichment also relies on uranium halides.

Using these methods, the output from enrichment can be directly used for the synthesis of UN fuel forms, as opposed to relying on an intermediate step to convert back to the oxide prior to synthesis. This method streamlines the fuel fabrication process by reducing intermediate steps while at the same time produces high quality uranium nitride material with lower energy inputs and higher atom efficiency compared to traditional methods.

The detailed description set forth above in connection with the appended drawings, where like numerals reference like elements, are intended as a description of various embodiments of the present disclosure and are not intended to represent the only embodiments. Each embodiment described in this disclosure is provided as a representative example or illustration and should not be construed as preferred or advantageous over other embodiments. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification. That is, the present disclosure includes embodiments that combine features from different embodiments.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

In the detailed description herein, references to “one embodiment,” “an embodiment,” “an example embodiment,” “some embodiments,” “one or more embodiments,” etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

In view of the limitations of the processing techniques available in the field, the terms “approximately”, “substantially”, and “about” reflect a certain inability (or uncertainty) to precisely control the exact dimensions of certain features and measurements described herein. Depending on the level of precision that can be achieved using the commercially available processing and measurement tools available at the time, the terms “approximately”, “substantially”, and “about” may be used to mean within ±5% of a target value for some features. The terms “approximately”, “substantially”, and “about” may include the target value. Furthermore, since all numbers, values, and expressions referring to quantities used herein are subject to the various uncertainties of measurement encountered in the art, then unless otherwise indicated, all presented values may be understood as modified by the various uncertainties of the respective measurements encountered in the art.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

The present application may also reference quantities and numbers. Unless specifically stated, such quantities and numbers are not to be considered restrictive, but exemplary of the possible quantities or numbers associated with the present application. The term “plurality” is meant to be any number that is more than one, for example, two, three, four, five, etc. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

### NON-LIMITING EMBODIMENTS

While general features of the disclosure are described and shown and particular features of the disclosure are set forth in the claims, the following non-limiting embodiments relate to features, and combinations of features, that are explicitly envisioned as being part of the disclosure. The following non-limiting embodiments contain elements that are modular and can be combined with each other in any number, order, or combination to form a new non-limiting embodiment, which can itself be further combined with other non-limiting embodiments.

Embodiment 1. A method for producing uranium nitride, the method including: heating a vessel containing a blend including a uranium source, a chloride salt, a metal nitride, and a reductant under a non-participating cover gas, wherein the vessel is maintained at a reaction temperature and for a reaction time sufficient to produce a molten reaction mixture including the uranium nitride; and isolating the uranium nitride, wherein the uranium source is a uranium oxide or a uranium halide.

Embodiment 2. The method of Embodiment 1 or any other Embodiment, wherein the uranium oxide is selected from the group consisting of UO₂, UO₃, and UOₓ, where 1.9≤x≤3.

Embodiment 3. The method of any of Embodiments 1-2 or any other Embodiment, wherein the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

Embodiment 4. The method of any of Embodiments 1-3 or any other Embodiment, wherein the uranium halide is a mixed metal uranium halide.

Embodiment 5. The method of any of Embodiments 1~4 or any other Embodiment, wherein the chloride salt is selected from the group consisting of LiCl, NaCl, KCl, CaCl₂, and MgCl₂.

Embodiment 6. The method of any of Embodiments 1-5 or any other Embodiment, wherein the chloride salt includes a first chloride salt and a second chloride salt having a binary ratio of the first chloride salt and the second chloride salt, wherein the binary ratio is about a eutectic ratio.

Embodiment 7. The method of any of Embodiments 1-6 or any other Embodiment, wherein the metal nitride is an alkali metal nitride or an alkaline earth metal nitride.

Embodiment 8. The method of any of Embodiments 1-7 or any other Embodiment, wherein the alkali metal nitride is Li₃N or Na₃N.

Embodiment 9. The method of any of Embodiments 1-8 or any other Embodiment, wherein the alkaline earth metal nitride is Mg₃N₂ or Ca₃N₂.

Embodiment 10. The method of any of Embodiments 1-9 or any other Embodiment, wherein the reductant is an alkali metal, an alkaline earth metal, an alkali metal hydride, or an alkaline earth metal hydride.

Embodiment 11. The method of any of Embodiments 1-10 or any other Embodiment, wherein the reductant is selected from the group consisting of Li, Na, Mg, Ca, LiH, NaH, KH, CaH₂, MgH₂, and RbH.

Embodiment 12. The method of any of Embodiments 1-11 or any other Embodiment, wherein the non-participating cover gas is nitrogen, CO₂, or a noble gas.

Embodiment 13. The method of any of Embodiments 1-12 or any other Embodiment, wherein the vessel is an alumina vessel, a nickel vessel, a tantalum vessel, or a molybdenum vessel.

Embodiment 14. The method of any of Embodiments 1-13 or any other Embodiment, wherein the vessel is configured to produce uranium nitride in a batch process.

Embodiment 15. The method of any of Embodiments 1-14 or any other Embodiment, wherein the vessel is configured to produce uranium nitride in a flow process.

Embodiment 16. The method of any of Embodiments 1-15 or any other Embodiment, wherein the reaction temperature is between about 600° C. and 900° C.

Embodiment 17. The method of any of Embodiments 1-16 or any other Embodiment, wherein the reaction time is less than 24 hours, less than 10 hours, less than 8 hours, less than 6 hours, less than 4 hours, less than 2 hours, or less than 1 hour.

Embodiment 18. The method of any of Embodiments 1-17 or any other Embodiment, further including cooling the molten reaction mixture to a temperature below the melting point of the chloride salt to provide the uranium nitride and a salt byproduct.

Embodiment 19. The method of any of Embodiments 1-18 or any other Embodiment, further including rinsing the cooled molten reaction mixture with a polar aprotic solvent.

Embodiment 20. The method of any of Embodiments 1-19 or any other Embodiment, wherein the polar aprotic solvent is tetrahydrofuran (THF), dimethylformamide (DMF), or dimethyl sulfoxide (DMSO).

Embodiment 21. The method of any of Embodiments 1-20 or any other Embodiment, wherein cooling the molten reaction mixture includes cooling at a cooling rate.

Embodiment 22. The method of any of Embodiments 1-21 or any other Embodiment, wherein the cooling rate is between about 0.1° C./min to about 10° C./min.

Embodiment 23. The method of any of Embodiments 1-22 or any other Embodiment, wherein a stoichiometric ratio of the blend is 1 mole uranium source: between 1 mole and 2 moles alkali metal nitride: between 1 mole and 10 moles reductant: between 1.2 moles and 25 moles chloride salt.

Embodiment 24. The method of any of Embodiments 1-23 or any other Embodiment, wherein isolating the reaction includes hot filtering the reaction mixture, thereby providing the uranium nitride.

Embodiment 25. A composition including the uranium nitride produced by the method any of Embodiments 1-24 or any other Embodiment.

Embodiment 26. A method for producing uranium nitride, the method including: heating a nickel crucible containing a blend including a uranium source, Li₃N, Li or LiH, and LiCl under argon gas, wherein the nickel crucible is maintained at a reaction temperature of between about 700° C. and about 900° C. for 2 hours, thereby providing uranium nitride; and isolating the uranium nitride, wherein the uranium source is a uranium oxide or a uranium halide.

Embodiment 27. A system for producing uranium nitride, the system including: a vessel including a uranium-containing blend for forming a uranium nitride and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium nitride produced by the reaction of the uranium-containing blend.

Embodiment 28. The system of Embodiment 27 or any other Embodiment, wherein the vessel is a zirconia vessel, a nickel vessel, a tungsten vessel, a tantalum vessel, a stainless-steel vessel, or a molybdenum vessel.

Embodiment 29. The system of any of Embodiments 27-28 or any other Embodiment, wherein the uranium-containing blend includes a uranium source, a chloride salt, a metal nitride, and a reductant.

Embodiment 30. The system of any of Embodiments 27-29 or any other Embodiment, wherein the heating element is further configured to cool the vessel to a temperature below the melting point of the chloride salt.

Embodiment 31. The system of any of Embodiments 27-31 or any other Embodiment, wherein the reaction temperature is between about 600° C. and 900° C.

Embodiment 32. The system of any of Embodiments 27-32 or any other Embodiment, wherein the processing zone is a batch processing zone configured to isolate uranium nitride in a batch process.

Embodiment 33. The system of any of Embodiments 27-33 or any other Embodiment, wherein the processing zone is a flow processing zone configured to continuously isolate uranium nitride in a flow process.

While illustrative embodiments have been illustrated and described, it will be appreciated that various changes can be made therein without departing from the spirit and scope of the invention.

What is claimed is:

1. A method for producing uranium nitride, the method comprising:
heating a vessel containing a blend comprising a uranium source, a chloride salt, a metal nitride, and a reductant under a non-participating cover gas, wherein the vessel is maintained at a reaction temperature and for a reaction time sufficient to produce a molten reaction mixture comprising the uranium nitride; and
isolating the uranium nitride,
wherein the uranium source is a uranium oxide or a uranium halide.

2. The method of claim 1, wherein the uranium oxide is selected from the group consisting of UO₂, UO₃, and UOₓ, wherein 1.9≤x≤3.

3. The method of claim 1, wherein the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UL₆, and combinations thereof.

4. The method of claim 1, wherein the uranium halide is a mixed metal uranium halide.

5. The method of claim 1, wherein the chloride salt is selected from the group consisting of LiCl, NaCl, KCl, CaCl₂, and MgCl₂.

6. The method of claim 1, wherein the chloride salt comprises a first chloride salt and a second chloride salt having a binary ratio of the first chloride salt and the second chloride salt, wherein the binary ratio is about a eutectic ratio.

7. The method of claim 1, wherein the metal nitride is an alkali metal nitride or an alkaline earth metal nitride.

8. The method of claim 7, wherein the alkali metal nitride is Li₃N or Na₃N.

9. The method of claim 7, wherein the alkaline earth metal nitride is Mg₃N₂ or Ca₃N₂.

10. The method of claim 1, wherein the reductant is an alkali metal, an alkaline earth metal, an alkali metal hydride, or an alkaline earth metal hydride.

11. The method of claim 10, wherein the reductant is selected from the group consisting of Li, Na, Mg, Ca, LiH, NaH, KH, CaH₂, MgH₂, and RbH.

12. The method of claim 1, wherein the non-participating cover gas is nitrogen, CO₂, or a noble gas.

13. The method of claim 1, wherein the reaction temperature is between about 600° C. and 900° C.

14. The method of claim 1, wherein the reaction time is less than 24 hours.

15. The method of claim 1, wherein a stoichiometric ratio of the blend is 1 mole uranium source: between 1 mole and 2 moles alkali metal nitride: between 1 mole and 10 moles reductant: between 1.2 moles and 25 moles chloride salt.

16. A composition comprising the uranium nitride produced by the method of claim 1.

17. A system for producing uranium nitride, the system comprising:
a vessel comprising a uranium-containing blend for forming a uranium nitride and a non-participating cover gas;
a heating element operatively coupled to the vessel, the heating element being configured to maintain the vessel at a reaction temperature sufficient to produce a reaction mixture of the molten uranium-containing blend; and
a processing zone fluidly coupled to the vessel, the processing zone being configured to isolate the uranium nitride produced by the reaction of the uranium-containing blend.

18. The system of claim 17, wherein the vessel is a zirconia vessel, a nickel vessel, a tungsten vessel, a tantalum vessel, a stainless-steel vessel, or a molybdenum vessel.

19. The system of claim 17, wherein the uranium-containing blend comprises a uranium source, a chloride salt, a metal nitride, and a reductant, wherein the uranium source is a uranium oxide or a uranium halide.

20. The system of claim 17, wherein the reaction temperature is between about 600° C. and 900° C.
